(19) United States
(12) Patent Application Publication
(10) Pub. No.: US 2014/0053823 A1
(43) Pub. Date: Feb. 27, 2014

(54) PORTABLE, ALL-TERRAIN OUTDOOR BARBEQUE GRILL

(71) Applicant: Charles G. Frantz, Weatherford, OK (US)

(72) Inventor: Charles G. Frantz, Weatherford, OK (US)

(73) Assignee: PARTY KING GRILLS CO., LLC, Weatherford, OK (US)

(21) Appl. No.: 13/595,046

(22) Filed: Aug. 27, 2012

(51) Int. Cl. A47J 37/07

(52) U.S. Cl. 126/276; 126/25 R; 126/39 B

(57) ABSTRACT

An outdoor barbeque grill that is removably securable to a receiver hitch at the rear end of a vehicle. The outdoor grill is designed to be portable in all terrains and landscapes, including for use while at home, camping or tailgating. The outdoor grill includes a grill head mounted to a grill cabinet. The grill cabinet is constructed from a structural frame having at least a receiver tube engaged with a drawbar tube. The drawbar tube may include a beveled terminal end, which engages the vehicle's receiver hitch and aids in securing the grill directly to the vehicle.

### 1. FIELD OF THE INVENTION

This invention relates generally to a portable, all-terrain outdoor barbeque grill, and more particularly an outdoor barbeque grill constructed to be directly attachable to a hitch receiver at the rear end of a vehicle while being transferred, and constructed to be easily moved by a user once detached from the receiver hitch.

### 2. DESCRIPTION OF THE RELATED ART

Due to the growing popularity of leisure, recreational and other outdoor activities, such as fishing, camping, cookouts and tailgating at sporting and other events, numerous approaches and devices have been devised to permit the people partaking in and attending these events to take various outdoor accessories, in particular various outdoor grilling accessories. In some cases a campfire may be built; however, campfires may be difficult to build and many of these venues do not permit campfires. A public barbeque grill may be utilized; however, many of these public grills are unsanitary, in a state of disrepair or not available at the particular venue. Another option is for the person to bring a personal grill to be set up and used at the venue; however, transporting a grill occupies much of the valuable storage inside the vehicle, plus the grill may not be packed away until it has completely cooled. A personal grill may be permanently attached to the vehicle, which may be unsatisfactory for many people because of the trouble associated therewith when the grill is not in use during their daily activities. A grill may be attached to a trailer to be hauled behind the vehicle; however, this results in the rear door of the vehicle being blocked when the barbeque and trailer are attached.

It is therefore desirable to provide a portable, all-terrain outdoor barbeque grill directly securable to the rear end of the vehicle.

It is further desirable to provide a portable, all-terrain outdoor barbeque grill that is quickly and effortlessly attached and detached from the hitch receiver by a user.

It is yet further desirable to provide a portable, all-terrain outdoor barbeque grill that does not require a separate swing arm or waste of valuable interior cargo room of the vehicle, leaving the cargo room for supplies and other personal affects.

### SUMMARY OF THE INVENTION

In general, in a first aspect, the invention relates to a portable, all-terrain cabinet for an outdoor grill. The cabinet includes a structural frame having an upper end configured for receipt of a grill head. The structural frame can form an interior compartment configured to house a fuel tank. A plurality of wheels are attached to a lower end of the structural frame, and the wheels may include oversized dolly tires rotatably connected to the lower end of the structural frame. The cabinet can also include a generally U-shaped dolly handle attached to a rear side of the structural frame. The rear side of the structural frame has cross-member support beams to prevent warping of the cabinet during usage. Also, a receiver tube having a longitudinal bore is secured to the lower end of the structural frame. In addition, a drawbar tube, which may include at least one beveled terminal end, is receivable within the longitudinal bore of the receiver tube. The cabinet can also include a door hingedly attached to a front side of the structural frame.

The structural frame of the cabinet may be constructed from a first side frame, a second side frame opposing the first side frame, a front frame, and a rear frame opposing the front frame. In this configuration, the front frame and the rear frame are respectively attached to the first side frame and the second side frame forming the interior compartment of the cabinet. In addition, the cabinet may include a generally planar floor having an opening therethrough. The floor may be generally perpendicular to the first side frame, the second side frame, the front frame and the rear frame. Additionally, the first side frame, the second side frame and the rear frame may include outer sheet metal walls to enclose the interior compartment of the cabinet. Moreover, the receiver tube may be secured to the rear frame and the front frame below the floor of the cabinet. Opposing receiver tube plates can also be respectively secured to the rear frame and the front frame, and in this configuration, the receiver tube can be secured between the receiver tube plates. Each of the receiver plates has an opening axially aligned with the longitudinal bore of the receiver tube.

The cabinet can also include a tank holder assembly disposed within the interior compartment of the cabinet. The tank holder assembly can be constructed from a generally U-shaped tank holder base attached to the receiver tube. The tank holder base includes opposing arms having inwardly tapered terminal ends. In addition, a front loop member is attached to the arms of the tank holder base, and a rear loop member opposing the front loop member is also attached to the arms of the tank holder base. A tank support plate can be attached to an upper surface of the receiver tube, and be generally aligned along parallel planes with a floor. The tank support plate may further be disposed generally within a central opening of the floor.

In general, in a second aspect, the invention relates to an outdoor grill removably attachable to a hitch receiver at a rear end of a vehicle. The grill includes a grill head and a portable grill cabinet having the grill head mounted thereon. The cabinet is constructed from a structural frame. A receiver tube having a longitudinal bore is secured to the structural frame of the cabinet. A drawbar tube is receivable within the longitudinal bore of the receiver tube, and may include a beveled terminal end. Moreover, wheels, such as front casters and rear oversized dolly tires, along with a dolly handle having opposing arms, are attached to the cabinet.

The grill head of the outdoor grill can include a grill cover hingedly attached to a firebox. The grill head may be a natural gas or liquid propane grill head, a smoker grill head or a charcoal grill head. Additionally, at least one door may be hingedly attached to the cabinet. The structural frame can be constructed from a first side wall, a second side wall and a rear wall, with the rear wall having structural cross-beams to prevent warping of the cabinet during usage and/or due to heat. Furthermore, the outdoor grill can include a tank holder assembly attached to and disposed within the interior compartment of the cabinet.

### BRIEF DESCRIPTION OF THE DRAWINGS

FIG. 1 is a perspective view of an outdoor barbeque grill in accordance with an illustrative embodiment of the portable, all-terrain outdoor barbeque grill disclosed herein;

FIG. 2 is a perspective view of an example of a portable grill cabinet in accordance with an illustrative embodiment of the portable, all-terrain outdoor barbeque grill disclosed herein;

FIG. 3 is an exploded perspective view of the cabinet shown in FIG. 3;

FIG. 4 is a perspective view of an interior compartment of the grill cabinet shown in FIG. 3;

FIG. 5 is an exploded perspective view of an example of a tank holder assembly in accordance with an illustrative embodiment of the portable, all-terrain outdoor barbeque grill disclosed herein;

FIG. 6 is a perspective view of another example of a portable grill cabinet in accordance with an illustrative embodiment of the portable, all-terrain outdoor barbeque grill disclosed herein;

FIG. 7 is an exploded perspective view of the cabinet shown in FIG. 6;

FIG. 8 is a front view of the cabinet shown in FIG. 6;

FIG. 9 is a side view of the cabinet shown in FIG. 6; and

FIG. 10 is a rear view of the cabinet shown in FIG. 6.

Other advantages and features will be apparent from the following description, and from the claims.

### DETAILED DESCRIPTION OF THE INVENTION

The devices and methods discussed herein are merely illustrative of specific manners in which to make and use this invention and are not to be interpreted as limiting in scope.

While the invention has been described with a certain degree of particularity, it is to be noted that many modifications may be made in the construction and the arrangement of the structural and function details disclosed herein without departing from the scope of the invention. It is understood that the invention is not limited to the embodiments set forth herein for purposes of exemplification.

The description of the invention is intended to be read in connection with the accompanying drawings, which are to be considered part of the entire written description of this invention. In the description, relative terms such as “front,” “rear,” “lower,” “upper,” “horizontal,” “vertical,” “above,” “below,” “up,” “down,” “top” and “bottom” as well as derivatives thereof (e.g., “horizontally,” “downwardly,” “upwardly” etc.) should be construed to refer to the orientation as then described or as shown in the drawings under discussion. These relative terms are for convenience of description and do not require that the machine be constructed or the method to be operated in a particular orientation. Terms, such as “connected,” “connecting,” “attached,” “attaching,” “join” and “joining” are used interchangeably and refer to one structure or surface being secured to another structure or surface or integrally fabricated in one piece, such as by welding, binding with adhesives, riveting, threaded fasteners, or bending in the form of a crimped seam. Structural steel and sheet metal are the usual starting materials for fabrication, and welding wire, flux, and fasteners may join the fabricated pieces. Further, the fabricated pieces may be finished, such as with paint, powder coat, chrome or nickel plating.

An outdoor barbeque grill 10 is directly attachable to a hitch receiver at a rear end of a vehicle. Grill 10 is removably attached to a receiver hitch on a rear end of a vehicle (not shown). The receiver hitch may be a tubular trailer hitch readily available on sport utility vehicles, pickup trucks, vans and other recreational vehicles. The receiver hitch is typically constructed from a hollow tube that has a rearward facing female tubular end and aligning pin receiver holes in the sides of the hollow tube. A hitch locking pin (not shown) may be used to removably secure the grill 10 to the receiver hitch.

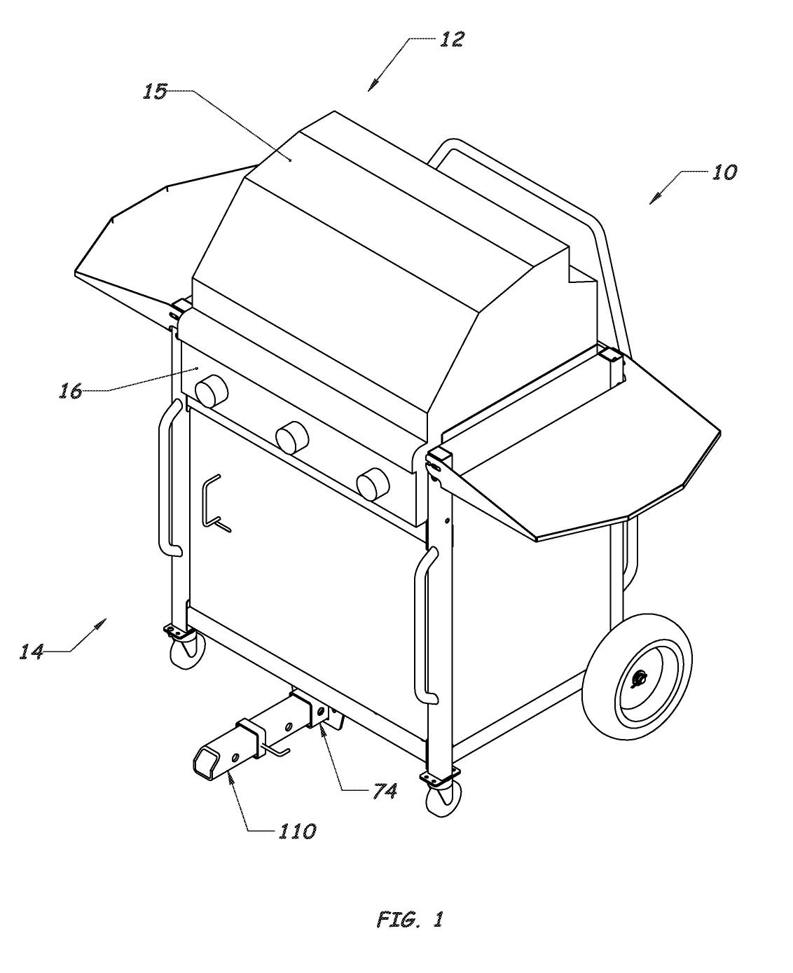

Referring to the figures of the drawings, wherein like numerals of reference designate like elements throughout the several views, and initially to FIG. 1, grill 10 includes a grill head 12 mounted atop a portable grill cabinet 14. Grill head 12 may be any conventional natural gas or liquid propane (LP), smoker, charcoal or the like grill head. For purposes of illustration and not for limitation, grill head 12 is illustrated as three-burner LP grill head, which is the widely used for home, tailgating and camping grilling. As will be appreciated, grill head 12 includes a grill cover 15 hingedly attached to a firebox 16, which houses a plurality of burners and grill grates forming a cooking surface (not shown). The burners are in fluid communication with a regulator (not shown) and a fuel source, such as a twenty-pound LP tank or one or more one-pound LP tanks (not shown), located within grill cabinet 14.

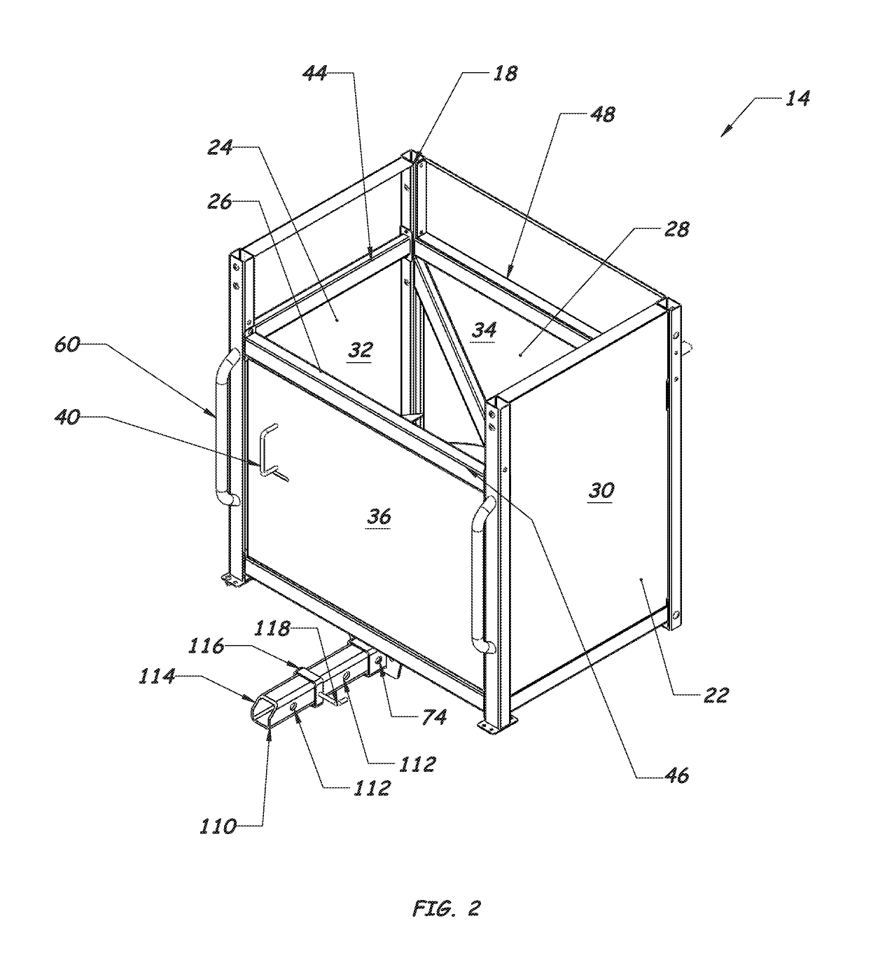

Referring now to FIGS. 2 through 4, portable grill cabinet 14 includes a structural frame 18 constructed from steel, as illustrated from structural steel square tubing, and a floor 20 having an opening 19 therethrough. Cabinet 14 may be fully enclosed, partially enclosed or fully open as illustrated throughout the drawings. Frame 18 may include a first side frame 22 and a second side frame 24 opposing first side frame 22. Structural frame 18 may also include a front frame 26 and a rear frame 28 opposing front frame 26. Both front frame 26 and rear frame 28 are respectively attached between first side frame 22 and second side frame 24 of cabinet 14. Cabinet 14 is illustrated as having a rectangular prism configuration; however, one having ordinary skill in the art will appreciate that other three-dimensional geometric configurations of cabinet 14 are possible. Based on this configuration, floor 20 is generally perpendicular to first side frame 22, second side frame 24, front frame 26 and rear frame 28. Each of the first side frame 22, the second side frame 24 and the rear frame 28 may include outer walls 30, 32 and 34, respectively, depicted as sheet metal walls. A door 36 is hingedly attached to cabinet 14 with at least two hinges 38, as depicted but not by way of limitation, pin hinges. Door 36 includes a handle 40 on an outer surface allowing accesses to the interior of cabinet 14.

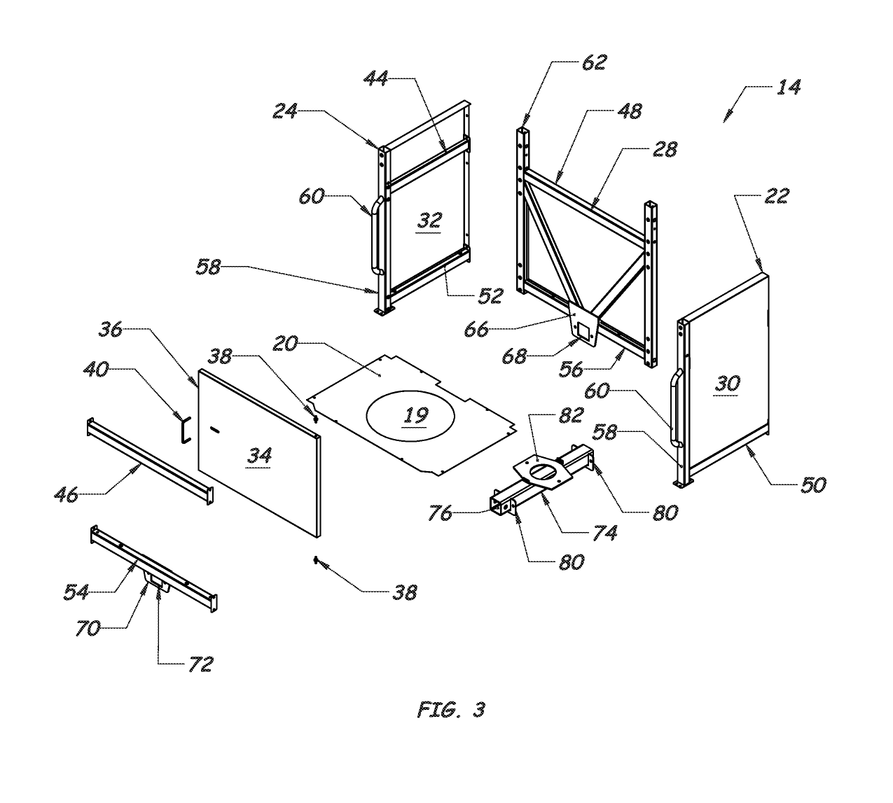

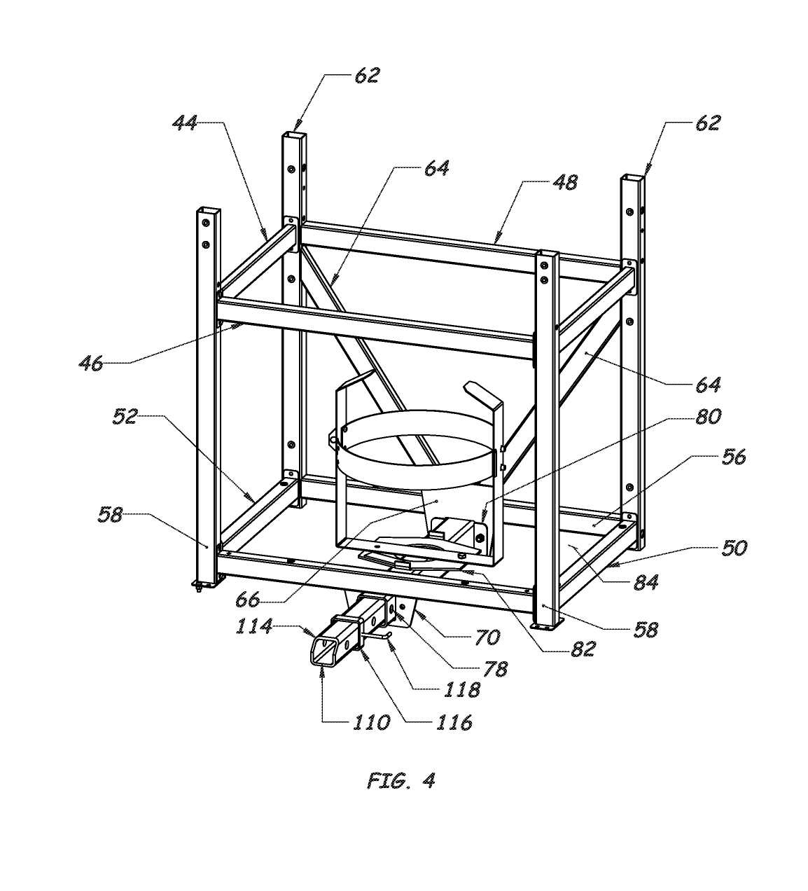

As seen in FIGS. 3 and 4, first side frame 22, second side frame 24, front frame 26 and rear frame 28 each respectively include an upper support beam 42, 44, 46 and 48 spaced from a parallel, lower support beam 50, 52, 54 and 56. Each of the lower support beams 50, 52, 54 and 56 are attached to floor 20 of cabinet 14. A terminal end of upper support beams 42 and 44 and lower support beams 50 and 52 of first side frame 22 and second side frame 24 are respectively connected to front support beams 58. Front support beams 58 are vertically aligned and generally perpendicular to upper support beams 42, 44, 46 and 48 and to lower support beams 50, 52, 54 and 56. Each of the front support beams 58 may include a longitudinal handle 60 attached thereto. Upper support beam 46 and the lower support beam 54 of front frame 26 are attached between front support beams 58 of first side frame 22 and second side frame 24. Rear frame 28 includes rear support beams 62 that are attached to terminal ends of upper support beam 48 and lower support beam 56. Rear support beams 62 may be generally aligned in parallel to each other, generally aligned in parallel to front support beams 58 and generally aligned perpendicular to upper support beam 48 and lower support beam 56. Rear frame 28 may also include cross-support beams 64 to prevent warping of cabinet 14 during usage and/or due to heat, such as depicted as having a generally V-shape alignment. Cross-support beams 64 may have upper terminal ends attached generally below an attachment point of upper support beam 48 and rear support beams 62 and lower terminal ends attached to lower support beam 56 of rear frame 28 intermediate of rear support beams 62.

Rear frame 28 may also include a receiver tube rear plate 66 having an opening 68 therethrough. Receiver tube rear plate 66 is connected to an inner surface of lower support beam 56 of rear frame 28. A receiver tube front plate 70 may be connected to an inner surface of lower support beam 54 of front frame 26, and may also include an opening 72 therethrough that is axially aligned with the opening 68 of the receiver tube rear plate 66.

A receiver tube 74 is connected between receiver tube rear plate 66 and receiver tube front plate 70. Receiver tube 74 includes a longitudinal bore 76 that is axially aligned with opening 72 of receiver tube front plate 70 and opening 68 of receiver tube rear plate 66. Opposing sides at terminal ends of receiver tube 74 include aligned holes 78. Receiver tube 74 may also include generally U-shaped fastener plates 80, which straddle receiver tube 74 and which may be respectively connected to receiver tube rear plate 66 and receiver tube front plate 70. Receiver tube 74 may also include a tank support plate 82 connected to an upper surface. Tank support plate 82 is generally aligned along parallel planes with floor 20, and is positioned within an opening 19 of floor 20 of cabinet 14.

Drawbar tube 110 is selectively received within bore 76 of and connected to receiver tube 74. As illustrated, drawbar tube 110 includes an array of holes 112 along opposing sides through which the hitch locking pin may pass. Array of holes 112 allows the user to selectively adjust the space between the vehicle and grill 10, when grill 10 is attached to the vehicle. Drawbar tube 110 also includes a beveled terminal end 114 along an upper surface. Beveled terminal end 114 of drawbar tube 110 aids the user in aligning drawbar tube 110 with the opening of the female end of the hitch receiver of the vehicle. Drawbar stop collar 116 may be adjustably connected to drawbar tube 110 in order to position grill 10 closer to or further from the vehicle. Drawbar tube 110 is sized and shaped to fit into the standard tubular hitch receiver or may be sized and shaped to fit other hitch receiver openings.

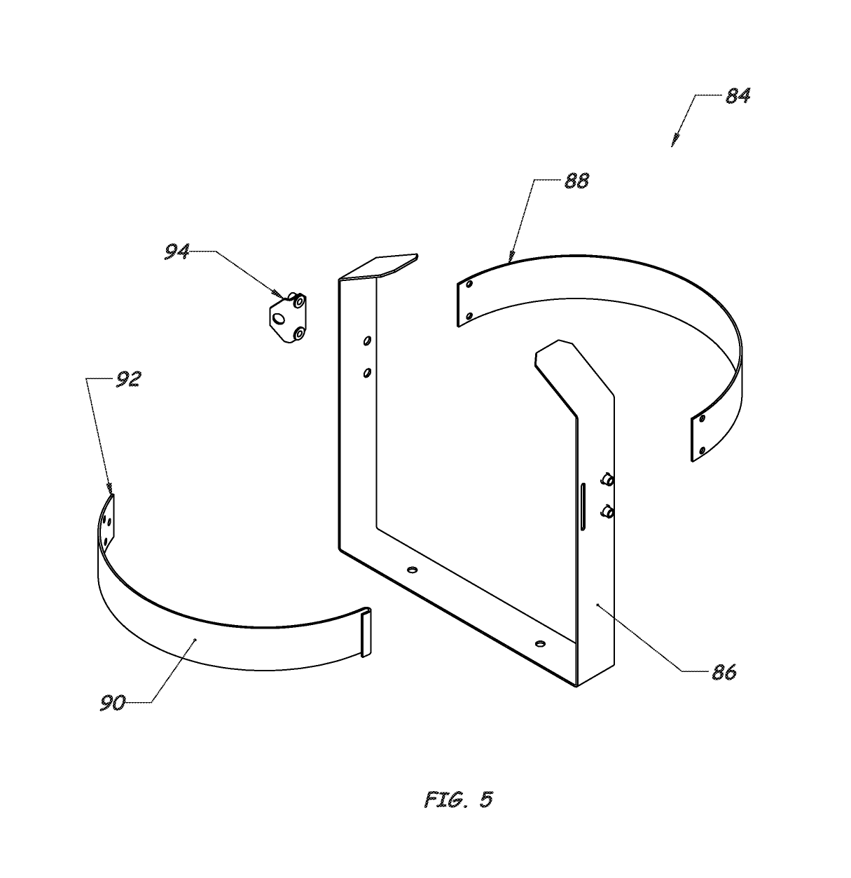

Grill 10 may further include a tank holder assembly 84 connected to tank support plate 82 within cabinet 14. Tank holder assembly 84 is constructed to retain the source of gas while grill 10 is attached to and being transported by the vehicle, while grill 10 is removed from the vehicle by a user, and also while grill 10 is being moved over all terrains to the user's preferred grilling location, whether that be at home, at a campsite, while tailgating or otherwise. As shown in FIG. 5, tank holder assembly 84 includes a generally U-shaped tank holder base 86. Terminal ends of tank holder base 86 are tapered inwardly, towards each other, in order to contact an upper surface of the tank. A rear loop member 88 opposes a front loop member 90 and is attached to tank holder base 86. Front loop member 90 may be attached to tank holder base 86 using a latch 92 that is releasably connectable with a tank latch catch 94. Tank latch catch 94 may be selectively adjusted by the user to clamp the tank as tightly as needed.

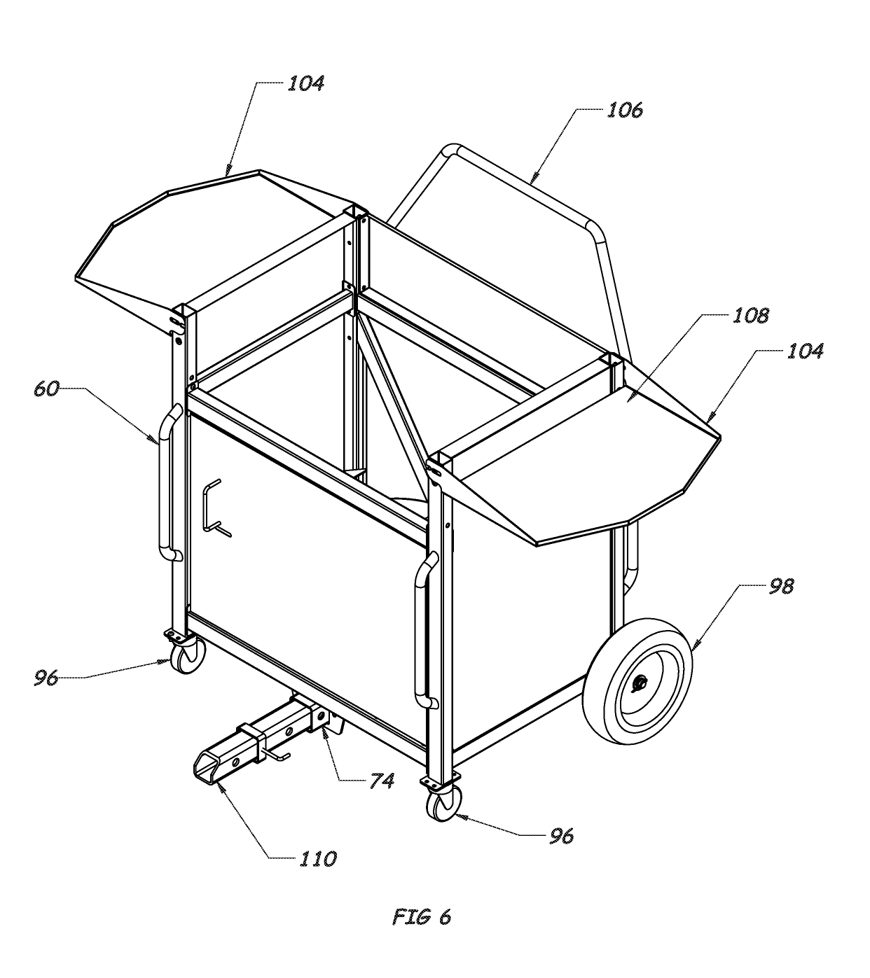

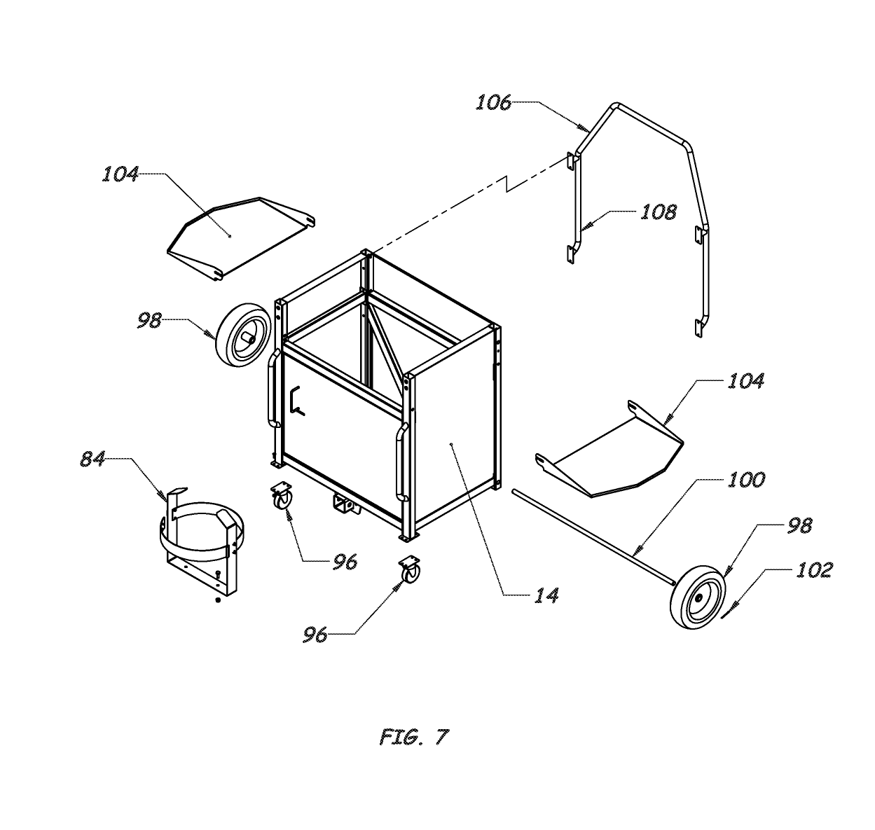

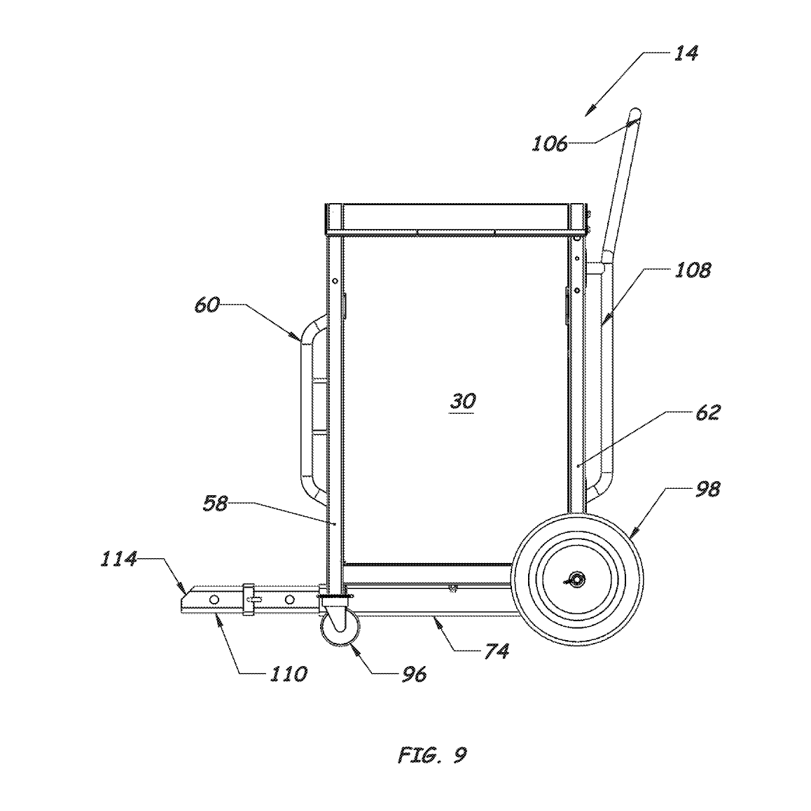

Turning now to FIGS. 6 through 10, grill 10 may also include a plurality of wheels attached to cabinet 14 so that grill 10 is portable from one location to another. As depicted, grill 10 includes casters 96 attached to lower terminal ends of front support beams 58. So that grill 10 can be transported over a variety of terrains and landscapes, grill 10 also includes oversized rear tires 98. The rear tires 98 can be dolly tires constructed as solid or inflatable, tubed or tubeless tires, which enable the grill 10 to be moved over uneven and/or off-road conditions. Rear tires 98 are connected to an axle 100, such as using cotter pins 102, and axle 100 is journaled within lower terminal ends of rear support beams 62 of rear frame 28.

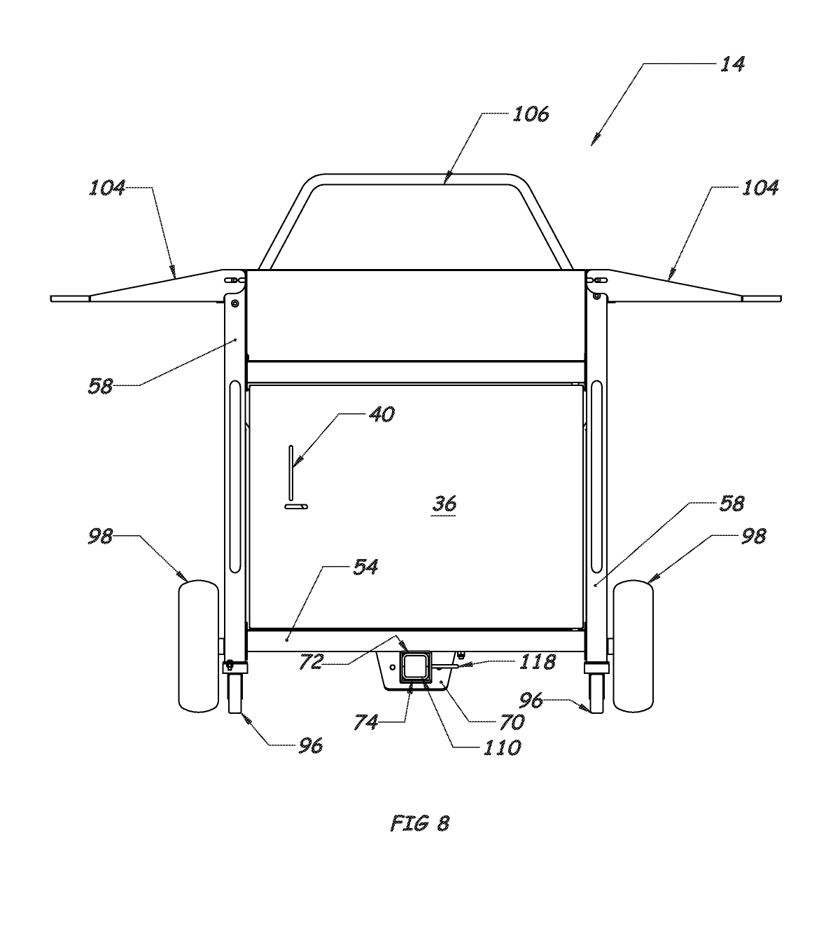

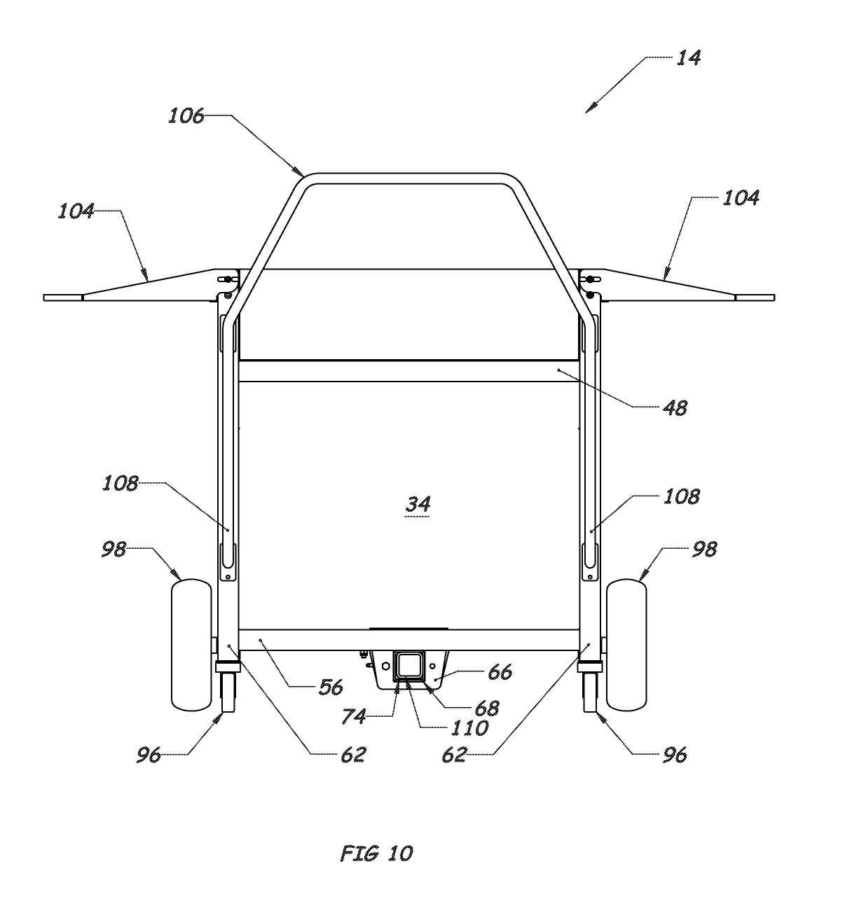

In addition, cabinet 14 may include one or more side tables 104. As shown in FIGS. 8 and 10, each of the side tables 104 is hingedly connected to the cabinet 14. Moreover, a rear handle 106 may be connected to rear frame 28 of cabinet 14, and in particular, rear handle 106 may be generally U-shaped with opposing arms 108 respectively attached longitudinally to rear support beams 62. Rear handle 106 allows the user to pull in an arc motion to pivot grill 10 along a vertical axis so that grill 10 can be easily moved from one location to another.

The opening of the female end of the hitch receiver is generally two inches by two inches, which is commonly provided in the standard tow package on most sport utility vehicles, pickup trucks and other recreational vehicles. To removably secure grill 10 to this type of hitch receiver, grill 10 is tilted back on rear tires 98 and beveled terminal end 114 of drawbar tube 110 is inserted into the rearward facing female end of the vehicle's receiver hitch. Grill 10 is then lifted by the user to longitudinally align receiver tube 110 and the receiver hitch, and is slid in until the selected holes 112 along opposing sides of drawbar tube 110 are aligned with the pin receiver holes in the receiver hitch. The hitch locking pin may be then inserted, securing grill 10 to the vehicle. At this point, stop collar 116 may be slide in contact with the receiver hitch and suitably secured into place, such as depicted using a generally L-shaped bolt 118. With stop collar 116 positioned according to the user's selection, grill 10 can subsequently be slid until the receiver hitch of the vehicle contacts stop collar 116 secured to drawbar tube 110, with holes 112 and the pin receiver holes in the receiver hitch of the vehicle being accurately aligned for receipt of the hitch locking pin. In keeping with the scope of the invention, a person having ordinary skill in the art will appreciate that grill 10 may be configured for use with other types of receiver hitches, such as but not limited to, draw bar and ball hitches (not shown).

Whereas, the devices and methods have been described in relation to the drawings and claims, it should be understood that other and further modifications, apart from those shown or suggested herein, may be made within the scope of this invention.

What is claimed is:

1. A portable, all-terrain cabinet for an outdoor grill, said cabinet comprising:
a structurally rigid frame having an upper end configured for receipt of a grill head;
a plurality of wheels rotatably attached to a lower end of said frame;
a dolly handle attached to said frame;
a receiver tube secured to said lower end of said frame, said receiver tube having a longitudinal bore; and
a drawbar tube receivable within said longitudinal bore of said receiver tube.

2. The cabinet of claim 1 further comprising a door hingedly attached to a front side of said frame.

3. The cabinet of claim 1 wherein said frame further comprises:
a first side frame;
a second side frame opposing said first side frame.
a front frame; and
a rear frame opposing said front frame;
wherein said front frame and said rear frame are respectively attached to said first side frame and said second side frame forming a compartment of said cabinet.

4. The cabinet of claim 3 further comprising a generally planar floor having an opening therethrough.

5. The cabinet of claim 4 wherein said floor is generally perpendicular to said first side frame, said second side frame, said front frame and said rear frame.

6. The cabinet of claim 3 wherein said first side frame, said second side frame and said rear frame include outer sheet metal walls.

7. The cabinet of claim 4 further comprising said receiver tube secured to said rear frame and said front frame of said cabinet below said floor.

8. The cabinet of claim 1 said drawbar tube comprising a beveled terminal end.

9. The cabinet of claim 1 further comprising a tank holder assembly attached to said cabinet.

10. The cabinet of claim 9 wherein said tank holder assembly further comprises:
a tank holder base attached to said receiver tube, said tank holder base comprising opposing arms having inwardly tapered terminal ends;
a front loop member attached to said arms of said tank holder base; and
a rear loop member opposing said front loop member and attached to said arms of said tank holder base.

11. The cabinet of claim 9 further comprising a tank support plate attached to an upper surface of said receiver tube, said tank support plate generally aligned along parallel planes with a floor, and said tank support plate disposed generally within a central opening of said floor.

12. An outdoor grill removably attachable to a hitch receiver at a rear end of a vehicle, said grill comprising:
a grill head;
a portable grill cabinet having an upper portion with said grill head mounted thereon, said cabinet comprising a structural frame;
a receiver tube secured to a lower portion of said structural frame of said cabinet, said receiver tube having a longitudinal bore;
a drawbar tube having a beveled terminal end, said drawbar tube receivable within said longitudinal bore of said receiver tube; and
a plurality of wheels attached to said cabinet.

13. The outdoor grill of claim 12 wherein said grill head further comprises a grill cover hingedly attached to a firebox.

14. The outdoor grill of claim 13 wherein said grill head is a natural gas or liquid propane grill head, a smoker grill head or a charcoal grill head.

15. The outdoor grill of claim 12 further comprising at least one door hingedly attached to said cabinet.

16. The outdoor grill of claim 12 wherein said structural frame further comprises a first side wall, a second side wall and a rear wall.

17. The outdoor grill of claim 16 wherein said rear wall further comprises structural cross-beams to prevent warping of said cabinet during usage and/or due to heat.

18. The outdoor grill of claim 12 further comprising a tank holder assembly attached to said cabinet.

19. The outdoor grill of claim 18 wherein said tank holder assembly further comprises:
a tank holder base attached to said receiver tube, said tank holder base comprising opposing arms having inwardly tapered terminal ends;
a front loop member attached to said arms of said tank holder base; and
a rear loop member opposing said front loop member and attached to said arms of said tank holder base.

20. The outdoor grill of claim 12 wherein said wheels further comprises a plurality of dolly wheels.

21. The outdoor grill of claim 12 further comprising a dolly handle having opposing arms attached to said cabinet.
